(19) United States
(12) Patent Application Publication
(10) Pub. No.: US 2025/0355253 A1
(43) Pub. Date: Nov. 20, 2025

(54) DISPLAY APPARATUS

(71) Applicant: CANON KABUSHIKI KAISHA, Tokyo (JP)

(72) Inventor: KAZUTAKA INOGUCHI, Tokyo (JP)

(21) Appl. No.: 19/204,238

(22) Filed: May 9, 2025

(30) Foreign Application Priority Data
May 15, 2024 (JP) 2024-079394

(51) Int. Cl. G02B 27/01

(52) U.S. Cl. CPC G02B 27/0172; G02B 27/0176

(57) ABSTRACT

A display apparatus includes an imaging system configured to image an outside world through an imaging optical system, and a display system configured to enable a displayed image to be observed by guiding light from a display element configured to display an original image including an outside-world image generated by the imaging system to an observer's eye through a display optical system. An entrance pupil in the imaging optical system is disposed on an outside world side of an observation position where the eye is disposed. The displayed image and a surrounding outside world outside the displayed image can be observed from the observation position. The display apparatus further comprises a shield configured to form a shielded area between the displayed image and the surrounding outside world.

### BACKGROUND

### Technical Field

The present disclosure relates to a display apparatus having an imaging system.

### Description of Related Art

A video see-through type head mount display (HMD) for use in mixed reality (MR) and augmented reality (AR) combines an outside-world image acquired by an imaging system with a computer graphics (CG) image and displays it to an observer (or viewer) via a display optical system.

PCT International Publication WO2008/096719 discloses a video see-through type HMD having a display optical system using a free-form prism having a transmissive surface, a transmissive reflective surface, and a reflective surface. This HMD provides the imaging system on the outside world side of the display optical system, displays an original image including an outside-world image acquired by the imaging system on the display element, and enlarges and displays the displayed image via the display optical system.

Japanese Patent No. 3604979 discloses a video see-through type HMD in which the entrance pupil in the imaging optical system is separated in the outside-world direction from the exit pupil in the display optical system, and the optical axis of the imaging optical system coincides with the optical axis of the display optical system.

### SUMMARY

One aspect of the disclosure provides a display apparatus that includes an imaging system configured to image an outside world through an imaging optical system, and a display system configured to enable a displayed image to be observed by guiding light from a display element configured to display an original image including an outside-world image generated by the imaging system to an observer's eye through a display optical system. An entrance pupil in the imaging optical system is disposed on an outside world side of an observation position where the eye is disposed. The displayed image and a surrounding outside world outside the displayed image can be observed from the observation position. The display apparatus further comprises a shield configured to form a shielded area between the displayed image and the surrounding outside world.

Further features of various embodiments of the disclosure will become apparent from the following description of embodiments with reference to the attached drawings.

### BRIEF DESCRIPTION OF THE DRAWINGS

FIG. 1 is a YZ sectional view of an HMD according to a first embodiment.

FIG. 2 is a YZ sectional view illustrating a state in which a right eye has rotated in the HMD according to one or more aspects of the present disclosure.

FIG. 3 is an XZ sectional view of the HMD according to one or more aspects of the present disclosure.

FIGS. 4A to 4C explain an effect of the first embodiment.

FIG. 5 is a YZ sectional view of an HMD according to one or more aspects of the present disclosure.

FIG. 6 is a YZ sectional view of an HMD according to one or more aspects of the present disclosure.

FIG. 7 is a partially enlarged view of FIG. 6.

### DETAILED DESCRIPTION

Referring now to the accompanying drawings, a description will be given of embodiments according to the present disclosure.

The display apparatus according to each embodiment includes an imaging system configured to capture the outside world through an imaging optical system, and a display system that enables a displayed image to be observed by guiding light from a display element that displays an original image including an outside-world image generated by the imaging system to the observer's eyes via a display optical system. The display apparatus is a so-called video see-through+see-around view type HMD that enables the observer to observe the displayed image and the surrounding outside world outside the displayed image from observation positions where the observer's eyes are disposed.

Although not disclosed in International Patent WO2008/096719, such an HMD is demanded to give the observer a sense that the displayed image observed through the HMD and the surrounding (peripheral) outside world of the HMD coexist. However, as disclosed in International Patent WO2008/096719, in a case where the entrance pupil of the imaging optical system and the exit pupil of the display optical system are separated from each other, a magnification difference occurs in the displayed image relative to the surrounding outside world, and thereby the observer feels an unnatural discrepancy between the displayed image and the surrounding outside world. Each embodiment can reduce the sense of unnatural discrepancy between the display image and the surrounding outside world. The surrounding outside world is an outside world to be viewed by the observer without using the display optical system.

### First Embodiment

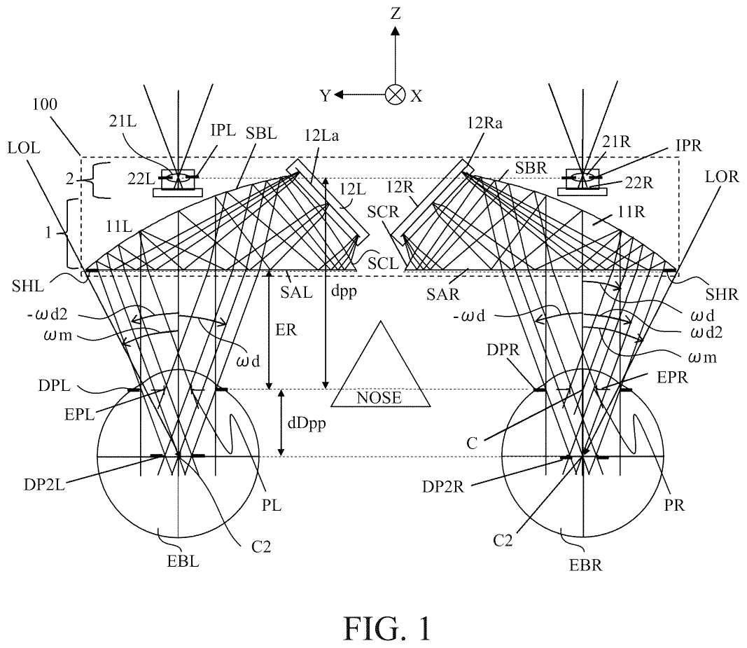

FIG. 1 illustrates the configuration of an HMD 100 as a display apparatus according to a first embodiment, viewed from above. FIG. 1 illustrates a YZ section as a horizontal section. The Y-axis is defined as an axis extending in the left-right (horizontal) direction (first direction), the Z-axis is defined as an axis extending in a visual axis direction as a front-back (depth) direction (up-down (vertical) direction in FIG. 1), and the X-axis is defined as an axis extending in a direction orthogonal to the paper plane in FIG. 1 (second direction: actual vertical direction). The HMD 100 is attached in front of the right eye EBR and left eye EBL on the observer's head. The observer's nose NOSE is located between the right eye EBR and the left eye EBL.

The HMD 100 includes a display system 1, and an imaging system 2 disposed on the outside world side of the display system 1 of a prism element described later. The display system 1 includes a right-eye display system having a right-eye display optical system 11R and a right-eye display element 12R, and a left-eye display system having a left-eye display optical system 11L and a left-eye display element 12L. The imaging system 2 includes a right-eye imaging system having a right-eye imaging optical system 21R and a right-eye image sensor 22R, and a left-eye imaging system having a left-eye imaging optical system 21L and a left-eye image sensor 22L.

IPR and IPL denote entrance pupils in the right-eye imaging optical system 21R and the left-eye imaging optical system 21L, respectively. The right-eye imaging optical system 21R and the left-eye imaging optical system 21L form optical images of the outside world (outside-world images) on the right-eye image sensor 22R and the left-eye image sensor 22L, respectively. The right-eye outside-world image and the left-eye outside-world image, which are captured images generated based on the imaging signals from the right-eye image sensor 22R and the left-eye image sensor 22L, are displayed as original images on the right-eye display element 12R and the left-eye display element 12L, respectively. At this time, an original image in which a CG image is combined with an outside-world image may be displayed on the display elements 12R and 12L.

The right-eye display optical system 11R and the left-eye display optical system 11L guide the display light from the right-eye display element 12R and the left-eye display element 12L, respectively, to the right eye EBR and the left eye EBL of the observer, and display the displayed images corresponding to the original image at the same size or enlarged size so that they can be observed by the observer.

The right-eye and left-eye display systems and the right-eye and left-eye imaging systems have the same configurations, and the components on the right-eye side and the components on the left-eye side are suffixed with the letters R and L, respectively.

The right-eye display optical system 11R has three surfaces, an incident surface SCR, a reflective surface SBR, and an optical surface (reflective surface, exit surface) SAR that serves both as a transmissive surface and a reflective surface, and includes an optical element (referred to as a prism element hereinafter) having a decentered prism shape whose interior is filled with a medium having a refractive index greater than 1. That is, the right-eye display optical system 11R has the incident surface SCR, the reflective surface SBR, and the optical surface SAR that serves as both a reflective surface and an exit surface.

A light beam (right-eye display light) emitted from the display surface 12Ra of the right-eye display element 12R enters the prism element from the incident surface SCR of the right-eye display optical system 11R. Inside the prism element, the light beam travels from the display element side toward the right (outside in the left-right direction), is reflected once on the optical surface SAR, and travels further toward the right. Then, the light beam is reflected again on the reflective surface SBR, exits from the optical surface SAR, and is guided to the exit pupil (referred to as a right-eye exit pupil hereinafter) DPR in the right-eye display optical system 11R. The right eye EBR of the observer is disposed at the right-eye exit pupil DPR as the observation position. Thus, the right-eye display optical system 11R reflects the light beam exiting from the display surface 12Ra a plurality of times (twice in this embodiment) in the horizontal plane, folding the optical path and guiding it to the right-eye exit pupil DPR.

At this time, a light ray that exits from the center of the display surface (display area) 12Ra of the right-eye display element 12R and is guided to a center C of the right-eye exit pupil DPR is called a central angle-of-view principal-ray, and this central angle-of-view principal-ray travels parallel to the Z-axis after being reflected on the reflective surface SBR. In this embodiment, a straight line along the optical path that this central angle-of-view principal-ray follows after exiting from the right-eye display optical system 11R is set as an optical axis of the right-eye display optical system 11R.

A right ray emitted from each point (pixel) on the display surface 12Ra of the right-eye display element 12R travels in the negative direction in the Y-axis direction (outside direction of the HMD 100) in a segment including in order from the incident surface SCR, the optical surface SAR, and the reflective surface SBR. This light ray also travels in the negative, positive, and negative directions in the Z-axis direction in this order in the segment including in order from the incident surface SCR, the optical surface SAR, the reflective surface SBR, and the optical surface SAR. In other words, the optical path of the light ray is folded. Thereby, a thin right-eye display optical system 11R can be achieved in the Z-axis direction.

Similarly to the right-eye display optical system 11R, the left-eye display optical system 11L has three surfaces: an incident surface SCL, a reflective surface SBL, and an optical surface (reflective surface, exit surface) SAL that serves both as a transmissive surface and a reflective surface, and includes a prism element having a decentered prism shape whose interior is filled with a medium having a refractive index greater than 1. That is, the left-eye display optical system 11L has the incident surface SCL, the reflective surface SBL, and the optical surface SAL that serves as both a reflective surface and an exit surface.

A light beam (left-eye display light) emitted from the display surface 12La of the left-eye display element 12L enters the prism element from the incident surface SCL of the left-eye display optical system 11L. Inside the prism element, the light beam travels from the display element side toward the left (outside in the left-right direction), is reflected once by the optical surface SAL, and travels further toward the left. Then, the light beam is reflected again on the reflective surface SBL, exits from the optical surface SAL, and is guided to the exit pupil (referred to as a left-eye exit pupil hereinafter) DPL in the left-eye display optical system 11L. The right eye EBL of the observer is disposed at the left-eye exit pupil DPL as the observation position. Thus, the left-eye display optical system 11L reflects the light ray exiting from the display surface 12La a plurality of times (twice) in the horizontal plane, folding the optical path and guiding it to the left-eye exit pupil DPL.

At this time, the central angle-of-view principal-ray that exits from the center of the display surface (display area) 12La of the left-eye display element 12L and is guided to the center of the left-eye exit pupil DPL travels parallel to the Z-axis after being reflected on the reflective surface SBL. In this embodiment, a straight line along the optical path that this central angle-of-view principal-ray follows after exiting from the left-eye display optical system 11L is set as the optical axis of the left-eye display optical system 11L.

A light ray emitted from each point (pixel) on the display surface 12La of the left-eye display element 12L travels in the positive direction in the Y-axis direction (outside direction of the HMD 100) in a segment including in order from the incident surface SCL, the optical surface SAL, and the reflective surface SBL. The light ray also travels in the negative, positive, and negative directions in the Z-axis direction in this order in the segment including in order from the incident surface SCL, the optical surface SAL, the reflective surface SBL, and the optical surface SAL. In other words, the optical path is folded. Thereby, a thin left-eye display optical system 11L can be achieved in the Z-axis direction.

The display optical system does not necessarily have to include a prism element, and may include, for example, a combination of a lens and a mirror.

In a case where light beams incident on the optical surfaces SAR and SAL, which are reflective and transmissive surfaces, at an angle equal to or greater than the critical angle and are totally reflected, and are incident at an angle less than the critical angle and transmit through them, light utilization efficiencies become high. In addition, the divergent light beam emitted from a point on each of the display elements 12R and 12L is converted into a parallel light beam by the refraction effect when it passes through a corresponding one of the display optical systems 11R and 11L, and is guided to a corresponding one of the exit pupils DPR and DPL. Therefore, an observer who places his right eye EBR and left eye EBL so that their pupils PR and PL are located on the plane of the exit pupils DPR and DPL can observe the displayed images as virtual images at infinity relative to the original images displayed on the display elements 12R and 12L.

At this time, the light ray that exits from both ends of the display surface 12Ra on the YZ section and reaches the center C of the right-eye exit pupil DPR is a principal ray of the maximum display angle of view ±ωd relative to the optical axis of the right-eye display optical system 11R (referred to as a maximum angle-of-view principal-ray hereinafter). Therefore, the horizontal angle of view (HFOV) of the right-eye display system is 2×ωd. This is also true for the maximum angle-of-view principal-ray that exits from both ends of the display surface 12La on the YZ section and reaches the center of the left-eye exit pupil DPL, and the horizontal angle of view HFOV of the left-eye display system.

A right-eye imaging system is disposed on the outside world side of the right-eye display optical system 11R, and a left-eye imaging system is disposed on the outside world side of the left-eye display optical system 11L. The optical axis of the right-eye imaging optical system 21R in the right-eye imaging system coincides with the optical axis of the right-eye display optical system 11R, and the optical axis of the left-eye imaging system 21L in the left-eye imaging system coincides with the optical axis of the left-eye display optical system 11L. The term “coincide” here tolerates a shift caused by manufacturing errors and the like.

Since both the display optical systems 11R and 11L and the imaging optical systems 21R and 21L are thin in the Z-axis direction, a distance dpp in the Z-axis direction (visual axis direction) between the entrance pupils IPR and IPL in the imaging optical systems 21R and 21L and the exit pupils DPR and DPL in the display optical systems 11R and 11L can be reduced. Thereby, images can be observed with less discomfort in the MR space displayed by the HMD 100 relative to the real space as the outside world.

At this time, the size of the entire HMD 100 may be reduced by configuring the imaging optical systems 21R and 21L so that they do not include other folding optical systems, etc. Furthermore, the distance dpp (mm) may satisfy the following inequality:

$$15 \leq dpp \leq 45 .$$

In a case where dpp becomes lower than the lower limit of the inequality, the eye relief ER becomes insufficient, it becomes difficult for the observer to observe an image with their eyes disposed at the optimal positions, and each imaging optical system is to have a folding optical system or the like, which will increase the size and weight of the HMD 100. The eye relief ER corresponds to a distance from the exit pupils DPR and DPR to the display optical system 11R (optical surfaces SAR and SAL). In a case where dpp becomes higher than the upper limit of the inequality, it becomes difficult to observe a display image (MR space) with a less uncomfortable sense relative to the real space.

In the configuration of the HMD 100 according to this embodiment, the distance dpp cannot be 0, so there may be a discrepancy between the MR space observed by the HMD 100 and the surrounding outside world observed as the real space adjacent to the MR space.

Accordingly, this embodiment provides light shields (light shielding portions) SHR and SHL near the outer ends of the optical surfaces SAR and SAL in the left-right direction (first direction: also referred to as the horizontal direction hereinafter) to shield part of the external light from the surrounding outside world, that is, to shield the observer's field of view of a part of the peripheral outside world. The light shields SHR and SHL form a shielded area of a predetermined width between the MR space observed from the exit pupils DPR and DPL and the peripheral outside world. The light shields SHR and SHL are provided outside the optically effective areas of the optical surfaces SAR and SAL through which the display light beams directed toward the exit pupils DPR and DPL pass.

The light shield SHR on the right-eye side is set so that an angle of view ωm of a light ray LOR among the outside-world light that reaches a center C2 of a second pupil DP2R from the right outer side of the HMD 100, which light ray LOR reaches the center C2 at a minimum incident angle relative to the visual axis direction (optical axis direction) satisfies the following inequality (1). The second pupil DP2R refers to an area within a specified diameter of a plane located at a distance dDpp behind the exit pupil DPR (opposite to the outside world). By setting the distance dDpp to be approximately the same as the distance from the rotation center of the right eye EBR to the pupil of the right eye EBR (approximately 10 mm), this area is a place where a light beam approximately equivalent to a light beam that passes when the observer who places the pupil at the exit pupil DPR to view the center of the displayed image views an arbitrary point on the displayed image is condensed.

$$ω m > ω d \qquad ( 1 )$$

The light shield SHL on the left-eye side is set so that an angle of view −ωm of a light ray LOL among the outside-world light that reaches a center C2 of a second pupil DP2L from the left outside of the HMD 100, which light ray LOL reaches the center C2 at a minimum incident angle relative to the visual axis direction satisfies the following inequality (1′).

$$- ω m < - ω d \qquad ( {1}^{′} )$$

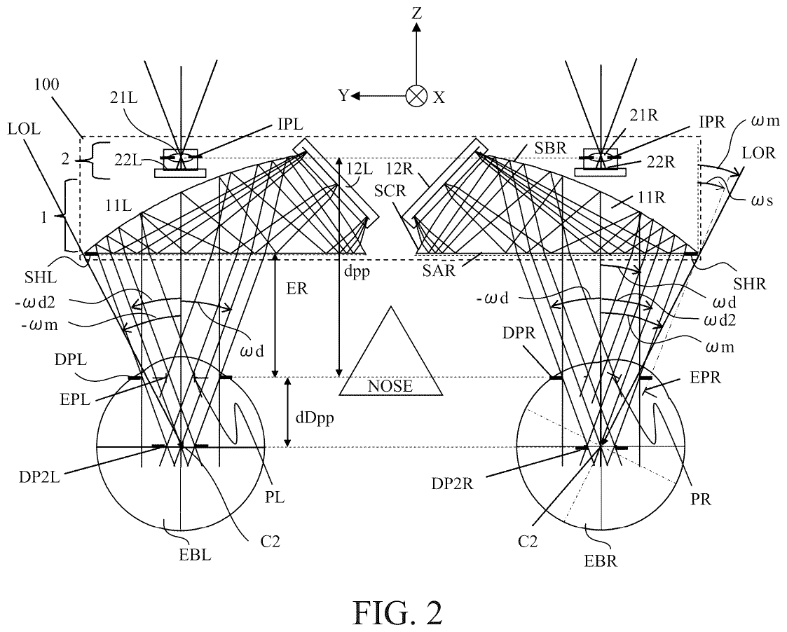

The observer can easily recognize the discrepancy between the MR space and the surrounding outside world when he gazes at the vicinity of the outer ends of the optical surfaces SAR and SAL. FIG. 2 illustrates a state in which the right eye EBR gazes at the right end of the optical surface SAR, i.e., the right eye (eyeball) EBR is rotated by ωm from the visual axis direction.

In FIG. 2, in a case where the light ray LOR enters the center of the pupil EPR of the right eye EBR, a light ray with an angle of view ωs (<ωm) enters the right end of the pupil EPR from the surrounding outside world. Therefore, strictly speaking, outside-world light with a minimum angle of view ωs enters the right eye EBR when the right eye EBR gazes at the vicinity of the right end of the optical surface SAR from the surrounding outside world. In this embodiment, the second pupil DP2R, which has a diameter of 4 mm, close to the pupil diameter when a normal person observes an image with a luminance of several tens of cd/m², is filled with a light beam with a maximum display angle of view ωd. Therefore, the maximum display half-angle-of-view ωd2 of the right-eye display system for the right-eye EBR rotated by ωm is equal to ωd. Therefore, the light shield SHR may be provided so as to satisfy the following inequality (2) for the right-eye EBR rotated by ωm.

$$ω s / ω d 2 > 1 \qquad ( 2 )$$

Satisfying this inequality can form a light shielded area between the MR space and the surrounding outside world, and reduce the degree to which the observer recognizes the discrepancy between the MR space and the surrounding outside world in the horizontal direction.

The light shield SHR may be provided so as to satisfy the following inequality (2′):

$$1.05 \leq ω s / ω d 2 \leq 1.5 \qquad ( {2}^{′} )$$

By setting ωs/ωd2 to the lower limit of inequality (2′) or higher, the degree to which the observer recognizes the discrepancy between the MR space and the surrounding outside world in the horizontal direction can be further reduced. As ωs/ωd2 is closer to the upper limit of inequality (2′), the observer is more likely to feel that the MR space and the surrounding outside world coexist in the horizontal direction.

The light shield SHR may be provided so as to satisfy inequality (2″).

$$1.1 \leq ω s / ω d 2 \leq 1.35 \qquad ( {2}^{″} )$$

By setting ωs/ωd2 to the lower limit of inequality (2″) or higher, the degree to which the observer recognizes the discrepancy between the MR space and the surrounding outside world in the horizontal direction can be further reduced. As ωs/ωd2 is closer to the upper limit of inequality (2″), the observer is more likely to feel that the MR space and the surrounding outside world coexist in the horizontal direction. Inequalities (2) to (2″) are similarly applicable to the light shield SHL on the left-eye side.

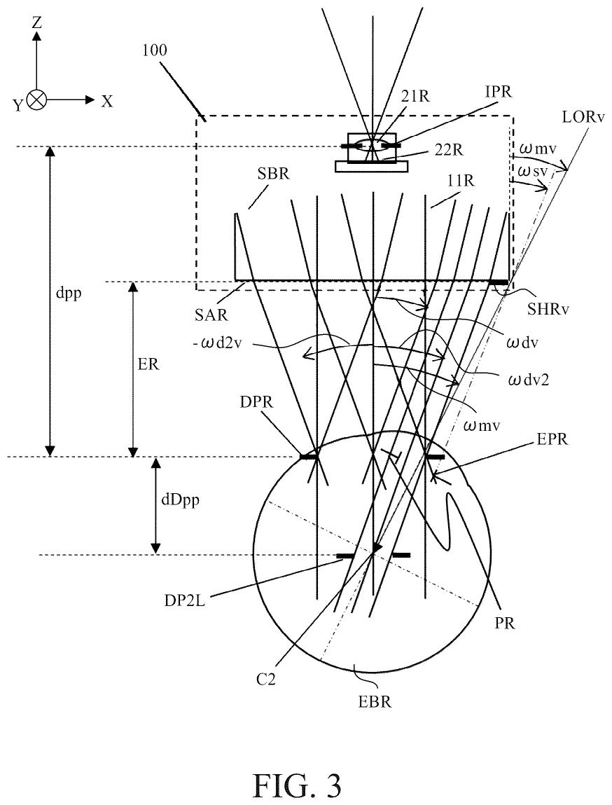

FIG. 3 illustrates the XZ section of the right-eye display system and right-eye imaging system. While FIG. 2 illustrates light shielding by the light shields SHR and SHL in the horizontal direction, FIG. 3 illustrates light shielding by the light shield SHR (SHL) in the vertical direction.

FIG. 3 illustrates the right eye EBR facing downward in order to explain the light shielding on the lower side, which is particularly important. The angles of view ωsv and ±ωd2v and light ray LORv are the angles of view equivalent to the angles of view ωs and ±ωd2 and light ray LOR in the horizontal direction illustrated in FIG. 2, labeled with a letter v.

In the vertical direction, the light shield SHR may be provided so as to satisfy the following inequality (3), which is an inequality similar to that for the horizontal direction:

$$ω sv / ω d 2 v > 1 \qquad ( 3 )$$

Satisfying this inequality can form a light shielded area between the MR space and the surrounding outside world, and reduce the degree to which the observer recognizes the discrepancy between the MR space and the surrounding outside world in the vertical direction.

Similarly to the horizontal direction, inequality (3) may be replaced with inequality (3′) below:

$$1.05 \leq ω sv / ω d 2 v \leq 1.5 \qquad ( {3}^{′} )$$

Inequality (3) may be replaced with inequality (3″) below:

$$1.1 \leq ω sv / ω d 2 v \leq 1.35 \qquad ( {3}^{″} )$$

Setting ωsv/ωd2v to the lower limit of inequality (3′) or (3″) or higher can reduce or further reduce the degree to which the observer recognizes the discrepancy between the MR space and the surrounding outside world in the vertical direction. As ωsv/ωd2v is closer to the upper limit of inequality (3′) or (3″), the observer can feel a stronger or much stronger sense that the MR space and the surrounding outside coexist in the vertical direction.

Since important information is often present near the observer's hands, feet, etc., on the lower side in the surrounding outside world of the HMD 100 rather than on the upper side, inequalities (3) to (3″) may be satisfied on the lower side of the HMD 100.

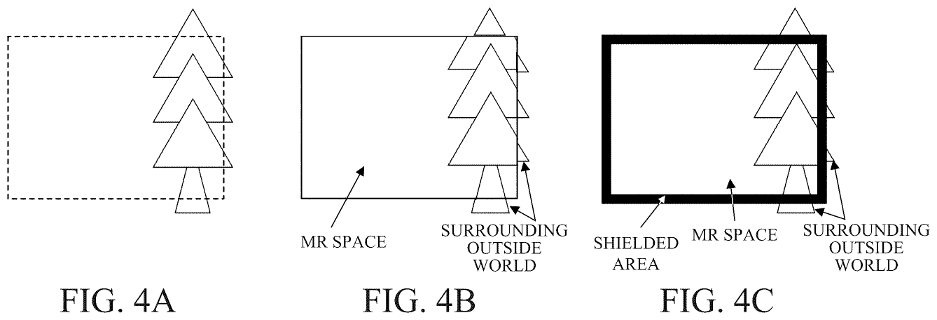

The effects of this embodiment will be described with reference to FIGS. 4A to 4C. FIG. 4A illustrates the real space observed without an HMD, and a broken-line frame illustrates a range observed as an image through the HMD.

FIG. 4B illustrates the MR space as an image observed through the conventional HMD using a solid-line frame and illustrates how the real space (surrounding outside world) appears shifted around it. As discussed above, due to the distance dpp being not 0, the magnification of the imaged MR space is larger than that of the surrounding outside world, and the resulting difference in size between the MR space and the surrounding outside world is recognized by the observer as the discrepancy. This discrepancy is particularly noticeable in a case where a distance to an object that straddles the MR space and the surrounding outside world is short.

FIG. 4C illustrates the MR space and the surrounding outside world observed through the HMD 100 according to this embodiment. In FIG. 4C, the magnification of the MR space is greater than that of the surrounding outside world, as in FIG. 4B. However, this embodiment provides the light shields SHR and SHL on the optical surfaces SAR and SAL of the display optical systems (prism elements) 11R and 11L and forms a shielded area that cannot be observed between the MR space that the observer can observe and the surrounding outside world. Thereby, the degree to which the observer recognizes the discrepancy between the MR space and the surrounding outside world can be reduced.

The shielded area may be formed to surround the entire outer perimeter of the MR space as illustrated in FIG. 4C, or may be formed in a part of the outer perimeter of the MR space.

### Second Embodiment

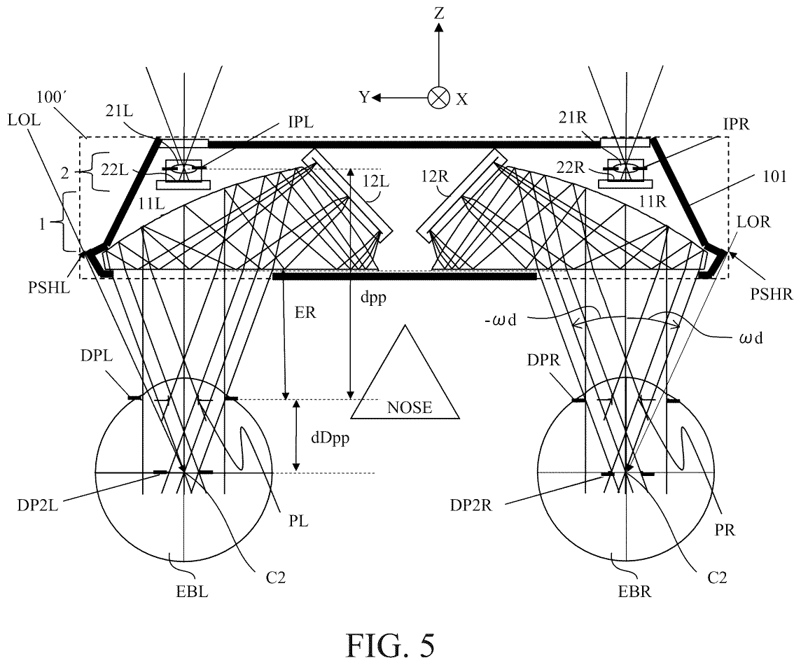

FIG. 5 illustrates a horizontal section (YZ section) of an TIMID 100′ according to a second embodiment. Instead of the light shields SHR and SHL formed on the optical surfaces SAR and SAL in the first embodiment, this embodiment uses a part of an exterior member 101 of the TIMID 100 as a light shield. The exterior member 101 has a light transmitting portion (illustrated in white in FIG. 5) made of a light transmitting material opposite to the optically effective areas of the optical surfaces SAR and SAL and the right-eye and left-eye imaging systems, and an exterior portion (illustrated in thick black lines) made of a light shielding material.

Each of a right-end convex portion PSHR and a left-end convex portion PSHL of the exterior portion shields a light ray with a smaller angle of view than the minimum angle of view (±ωm) that reaches the center C2 of the second pupils DP2R and DP2L among the outside-world light from the surrounding outside world. Each of a part of the exterior member 101 from the right end of the light transmitting portion on the right-eye side to the right-end convex portion PSHR and a part of the light transmitting portion on the left-eye side to the left-end convex portion PSHL corresponds to a light shield that forms a shielded area between the MR space and the surrounding outside world.

Thus, forming a shielded area using the exterior member 101 can reduce the degree to which the observer recognizes the discrepancy between the MR space and the surrounding outside world.

### Third Embodiment

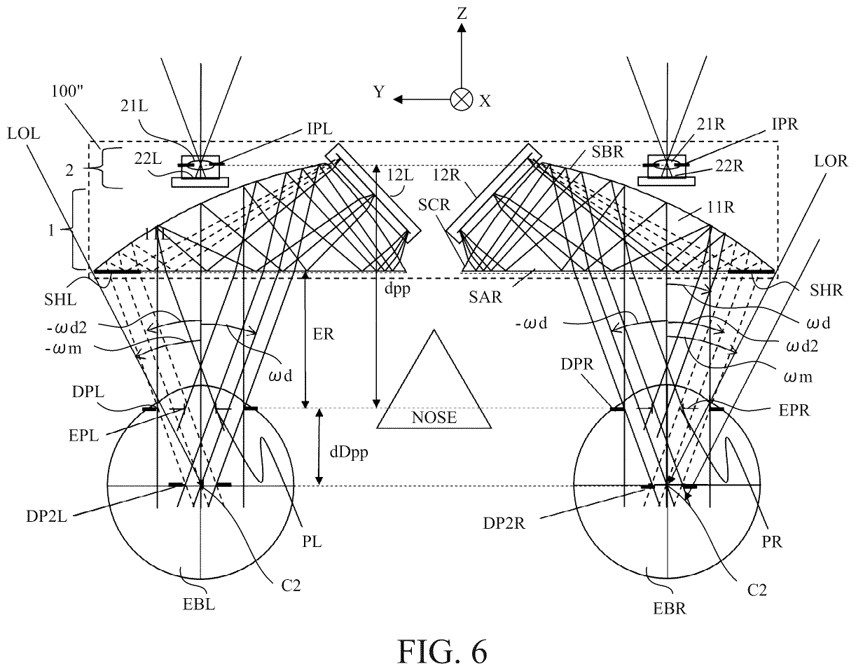

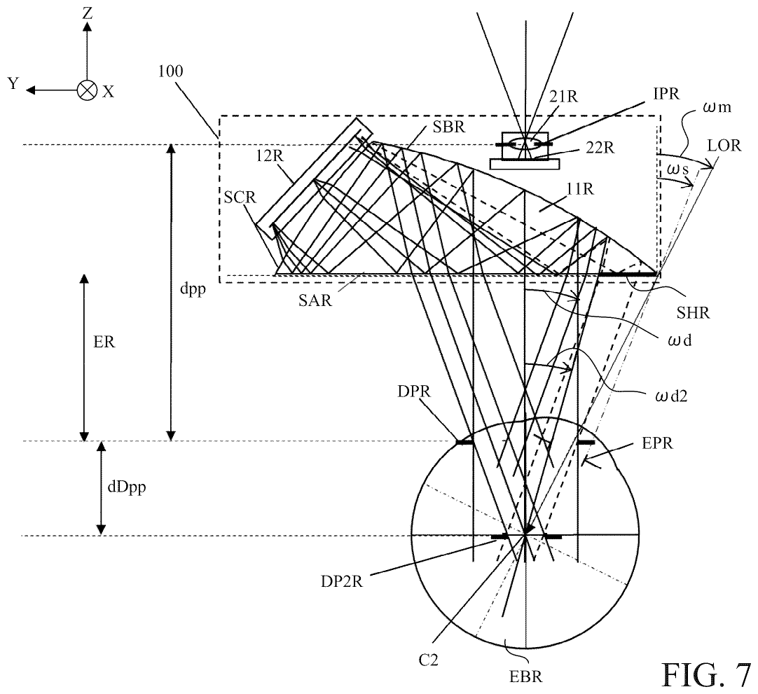

FIG. 6 illustrates a horizontal section (YZ section) of an HMD 100″ according to a third embodiment. FIG. 7 illustrates a state in which the right eye EBR is gazing at the right end of the right-eye display optical system (prism element) 11R in the HMD 100″.

The first embodiment provides the light shields SHR and SHL formed on the optical surfaces SAR and SAL of the prism elements outside the optically effective area of the optical surfaces SAR and SAL. On the other hand, this embodiment provides the light shields SHR and SHL so that they partially cover the optically effective area, that is, so as to make a left-right width of the optically effective area narrower than that of the first embodiment.

More specifically, as illustrated in FIG. 7, the light shield SHR is extended inward to a position where a light ray at the angle of view ωd no longer enters the second pupil DP2R with a diameter of 4 mm in comparison with the first embodiment. Thereby, the light shield SHR can be provided so as to satisfy the inequality (2) (or (2′) or (2″)) while the display light incident on the right eye EBR rotated by ωm and a reduction amount of the outside-world light from the surrounding outside world are reduced, and the size of the HMD 100″ is prevented from increasing, in comparison with the first embodiment.

In this embodiment, the maximum display half-angle-of-view ωd2 of the right-eye display system for the right eye EBR rotated by ωm from the visual axis direction is ωd2<ωd. In this case, the inner end of the light shield SHR may be disposed outside of ER (eye relief)×tan ωd so that angle-of-view light forming the angle of view ωd enters the pupil EPR when the right eye EBR faces the visual axis direction. Thereby, inequality (2) can be more easily satisfied in comparison with the first embodiment, while the horizontal angle of view when the right eye EBR faces the visual axis direction is 2×ωd, as in the first embodiment.

The first to third embodiments provide a light shield, and can reduce the degree to which an observer recognizes the discrepancy between an MR image and the surrounding outside world in a small HMD.

The first to third embodiments have discussed the HMD including the right-eye and left-eye imaging systems and the right-eye and left-eye display systems, but may provide an HMD including an imaging system and a display system for a single eye with a light shield equivalent to the light shield of the first to third embodiments.

The first to third embodiments provide physical shields on the optical surfaces SAR and SAL or the exterior member 101. In contrast, a shielded area as a black display area may be included in at least a part of the outer periphery of a displayed image (that is, an original image). In this case, the shield corresponds to an image processing circuit or the like that generates the original image to which the shielded area has been added. However, in a case where a black display area is generated in at least a part of the outer periphery of the displayed image (original image), an angle of view at which the MR space can be observed is reduced, and thus a physical shield as illustrated in the first to third embodiments may be provided to shield the surrounding outside world side.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment enables a displayed image and the outside world to be naturally observed.

This application claims priority to Japanese Patent Application No. 2024-079394, which was filed on May 15, 2024, and which is hereby incorporated by reference herein in its entirety.

What is claimed is:

1. A display apparatus comprising:
an imaging system configured to image an outside world through an imaging optical system; and
a display system configured to enable a displayed image to be observed by guiding light from a display element configured to display an original image including an outside-world image generated by the imaging system to an observer's eye through a display optical system,
wherein an entrance pupil in the imaging optical system is disposed on an outside world side of an observation position where the eye is disposed,
wherein the displayed image and a surrounding outside world outside the displayed image can be observed from the observation position, and
wherein the display apparatus further comprises a shield configured to form a shielded area between the displayed image and the surrounding outside world.

2. The display apparatus according to claim 1, wherein the display optical system includes an optical element configured to reflect the light from a display element side to outside and guide the light to the eye.

3. The display apparatus according to claim 1, wherein the shield is provided on an exit surface of the display optical system.

4. The display apparatus according to claim 1, further comprising an exterior member covering the display optical system,
wherein the shield is provided to the exterior member.

5. The display apparatus according to claim 1, wherein the shield is provided outside an optically effective area in the display optical system.

6. The display apparatus according to claim 1, wherein the shield is provided so as to partially cover an optically effective area in the display optical system.

7. The display apparatus according to claim 1, wherein the following equality is satisfied:
$$ω s / ω d 2 > 1$$
where in a first direction in which the light incident on the display optical system from the display element travels toward an exit surface of the display optical system, ωs is a minimum angle of view at which light from the surrounding outside world enters the eye in a surrounding view state in which the eye faces an edge on a surrounding outside world side of the shielded area, and ωd2 is a maximum display half-angle-of-view of the display system for the eye in the surrounding view state.

8. The display apparatus according to claim 7, wherein the following inequality is satisfied:
$$1.05 \leq ω s / ω d 2 \leq 1.5 .$$

9. The display apparatus according to claim 7, wherein the following inequality is satisfied:
$$ω sv / ω d 2 v > 1$$
where in a second direction orthogonal to a first direction in which the light incident from the display element to the display optical system travels toward an exit surface of the display optical system, ωsv is a minimum angle of view at which light from the surrounding outside world enters the eye in the surrounding view state, and ωd2v is a maximum display half-angle-of-view of the display system for the eye in the surrounding view state.

10. The display apparatus according to claim 1, wherein the imaging system and the display system are provided for each of a right eye and a left eye of an observer, and
wherein an outside is an outside of at least one of a left-right direction and an up-down direction.

11. The display apparatus according to claim 10, wherein the display optical system provided for each of the right eye and the left eye has an optical element that internally reflects the light from the display element from inside to outside in the left-right direction and guides the light to the eye.

12. The display apparatus according to claim 10, wherein the shielded area is included in the displayed image.

13. The display apparatus according to claim 1, wherein the surrounding outside world is an outside world to be viewed by the observer without using the display optical system.
